(19) United States
(12) Patent Application Publication
(10) Pub. No.: US 2007/0108103 A1
(43) Pub. Date: May 17, 2007

(54) Vibratory separators and operations

(75) Inventor: George Alexander Burnett, Aberdeen (GB)

Correspondence Address: Guy McClung, # 114, 5315B F.M. 1960 Rd. West, Houston, TX, 77069-4410, US

(73) Assignee: GUY MC CLUNG, SPRING, TX (US)

(21) Appl. No.: 11/280,975

(22) Filed: Nov. 16, 2005

(51) Int. Cl. B03B 7/00; B07B 9/00

(52) U.S. Cl. 209/17

(57) ABSTRACT

An improved upflow vibratory separator or shale shaker.

### BACKGROUND OF THE INVENTION

1. Field of the Invention

The present invention is directed to upflow vibratory separators and shale shakers with vibrators such as electromagnetic vibrators and/or piezoelectric vibrators and to methods of their use.

2. Description of Related Art

Vibratory separators are used in a wide variety of industries to separate materials such as liquids from solids or solids from solids. Typically such separators have a basket or other screen holding or mounting apparatus mounted in or over a receiving receptacle or tank and vibrating apparatus for vibrating the basket and thus the screen. One or more screens is mounted in the basket. Material to be treated is introduced to the screen(s) from above either by flowing it directly onto the screen(s) or by flowing it into a container, tank, or “possum belly” from which it then flows to the screen(s). Also in some multi-screen apparatuses material flows generally horizontally or uphill from one screen to another and, in certain systems, from an upper screen onto a lower screen.

In certain aspects, known systems are used to screen drilling fluids to remove debris during the drilling of boreholes particularly, but not exclusively, for drilling operations for hydrocarbons such as oil and gas.

Other known separators use a flow path in which material to be treated flows upwardly from beneath a screen and material, e.g. liquid or liquid plus some solids, that flows through the screen is recovered from above the screen. Material, e.g. solids that cannot pass through the screen, flow down and settle beneath the screen.

### SUMMARY OF THE INVENTION

The present invention, in certain aspects, discloses an upflow vibratory separator or shale shaker with: a box or basket; a primary screen assembly in the box or basket; a container, the box or basket and the primary screen assembly in the container; vibratory apparatus for vibrating the primary screen assembly or for vibrating the primary screen assembly and the box or basket; at least part of the container disposed beneath the primary screen assembly; and the vibratory apparatus comprising electromagnetic vibrator apparatus or piezoelectric vibrator apparatus. In one aspect, such a separator or shaker has a deflector adjacent a material input for directing material flowing through the material input away from the primary screen assembly.

In certain aspects, the present invention discloses, a method of removing debris from drilling fluid, comprising passing the fluid through a screen which lies in a plane which is not vertical so that one face of the screen is directed generally downwardly and the opposite face is directed generally upwardly, characterized by passing the fluid through the screen from the side of the screen having the generally downwardly directed face through to the side having the generally upwardly directed face, the improvement including vibrating the screen with non-motorized vibrator apparatus.

In certain aspects the present invention discloses an apparatus for removing debris from drilling fluid, comprising a screen which lies in a plane which is not vertical so that one face of the screen is directed generally downwardly and the opposite face is directed generally upwardly, and means for introducing the fluid to the screen such that the fluid passes through the screen from the side of the screen having the generally downwardly directed face through to the side having the generally upwardly directed face, the improvement including vibration apparatus for vibrating the screen, the vibration apparatus comprising non-motorized vibrator apparatus.

To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is schematic side cross-section view of a system according to the present invention.

FIG. 2A is a schematic side cross-section view of a system according to the present invention.

FIG. 2B is a cross-section view of part of the system of FIG. 2A.

FIG. 2C an end view of the system of FIG. 2A.

FIG. 3 is a schematic side cross-section view of a system according to the present invention.

FIG. 4A is a schematic side cross-section view of a system according to the present invention.

FIG. 4B is an end view of the system of FIG. 4A.

FIG. 4C is a cross-section view of the system of FIG. 4A.

FIG. 5A is a schematic side cross-section view of a system according to the present invention.

FIG. 5B is an end view of the system of FIG. 5A.

FIG. 6 is a top schematic view of a system according to the present invention.

### DESCRIPTION OF EMBODIMENTS PREFERRED AT THE TIME OF FILING FOR THIS PATENT

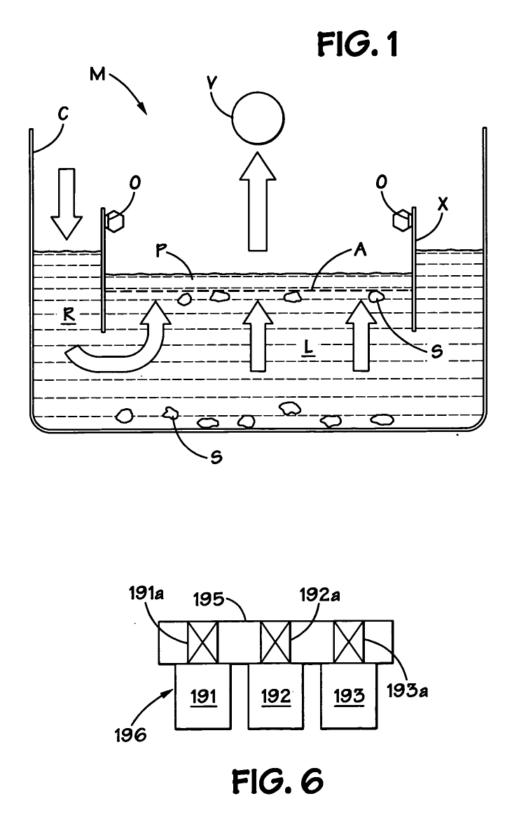

FIG. 1 shows a system M according to the present invention which has a container C into which material R is introduced, e.g. the material including liquid L and solids S. The material R flows to a screen apparatus A which is mounted in a basket or box X. Part P of the material, e.g. liquid or liquid plus some solids, flows up through the screen apparatus A. The part P is removed from the system by removal apparatus V (e.g. vacuum or pump apparatus). Part of the material, e.g. solids S and agglomerations or masses of solids, either settles down in the container C without contacting the screen apparatus A or, upon being prevented from further upward flow by the screen apparatus A and/or by material already adjacent the screen apparatus A, falls downwardly in the container C.

Electromagnetic vibrator apparatus B vibrates the basket X and, thus, the screen apparatus A. It is within the scope of the present invention to use one, two, three, four or more electromagnetic vibrator apparatuses (and to do so for any vibrator or vibration apparatus of any embodiment disclosed herein). It is within the scope of the present invention for the screen apparatus A (and the apparatus 110 described below) to be any suitable known screen or screen assembly used for vibratory separators or shale shakers. In one particular aspect the material R is drilling material with drilling fluid and drilled solids. Instead of, or in addition to, one or more electromagnetic vibrator apparatuses, according to the present invention, (as is true for any embodiment according to the present invention) one, two, three, four or more piezoelectric vibration apparatuses are used. Also, according to the present invention any vibrator or vibration apparatus of any embodiment according to the present invention may be connected directly to the screen apparatus instead of to the basket X. Appropriate mounts and/or isolators and/or shock absorbers O may be used to mount the vibrator or vibration apparatuses to a basket or directly to a screen apparatus.

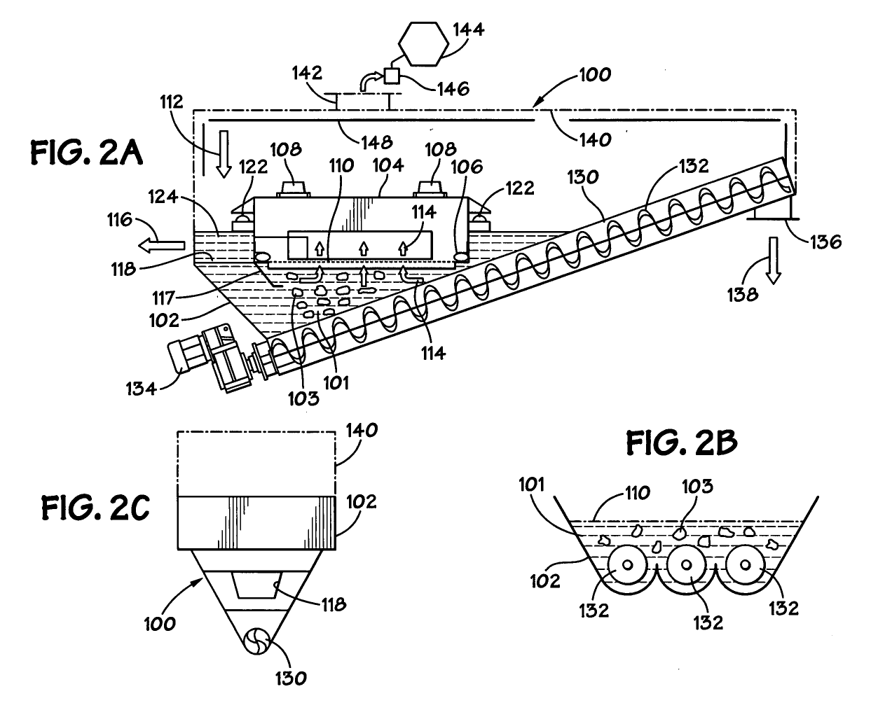

FIGS. 2A-2C illustrate a system 100 according to the present invention which has a housing 102 for containing material 101 to be treated. A screen apparatus 110 is removably secured to a box 104 which is mounted to the housing 102. Any known structure and/or apparatus may be used to removably secure the screen apparatus 110 to the box 104 and, as shown, in one aspect, a known inflatable seal apparatus 106 is used for this purpose.

Vibratory apparatus 108 (electromagnetic vibrator apparatus or piezoelectric vibrator apparatus) connected to the box 104 vibrates the box 104 and thus the screen apparatus 110. Any suitable known vibratory apparatus may be used for the vibratory apparatus 108. Any suitable known screen or screens, screen assembly or screen assemblies may be used for the screen apparatus 110. The box 104 is mounted on anti-vibration mounts 122. Optionally, the apparatus 108 is connected directly to the screen apparatus 110.

An arrow 112 indicates the introduction of the material 101 (including, but not limited to, drilling material including drilling fluid or mud, and drilled solids and debris) into the housing 102. Arrows 114 indicate the flow of the material 101 up to and, at least part thereof, through the screen apparatus 110. An arrow 116 indicates the discharge of recovered material, e.g. fluid and/or fluid plus solids, 124 through a discharge duct 118 from the box 104 (shown schematically in FIG. 7C). In one aspect the duct 118 is flexible or has a flexible portion so that the duct 118 and the box 104 can be lowered in the housing 102, e.g. for access, maintenance, or cleaning. A deflector 117 directs incoming fluid flow. Heavier and/or agglomerated solids, directed by the deflector 117, will flow downwardly to the conveyor system 130 and will not impact the screen apparatus 110.

Solids 103 that do not pass through the screen apparatus 110 fall within the housing 102 and enter a conveyor system 130. An auger apparatus 132 rotated by a motor 134 augers the solids S up to a discharge opening 136. An arrow 138 indicates the flow of the material with discharged solids from the system 100 to storage, to disposal, or to additional processing. In one aspect the auger, as shown, is inclined upwardly.

According to the present invention, one, two, three, four, or more auger apparatuses may be used with a system according to the present invention; e.g. the system 100 as shown in FIG. 7B has three auger apparatuses 132. Optionally, the system 100 is enclosed with an enclosure 140. In one aspect air, fumes, gases, and/or material entrained in air above the box 104 are evacuated through an access opening 142. Optionally this is accomplished by an HVAC system 144 and/or a filtration system 146 with appropriate pumping apparatus and/or vacuum apparatus. Optionally the enclosure 140 itself or the enclosure 140 with sound insulation material 148 reduces noise from the system 100.

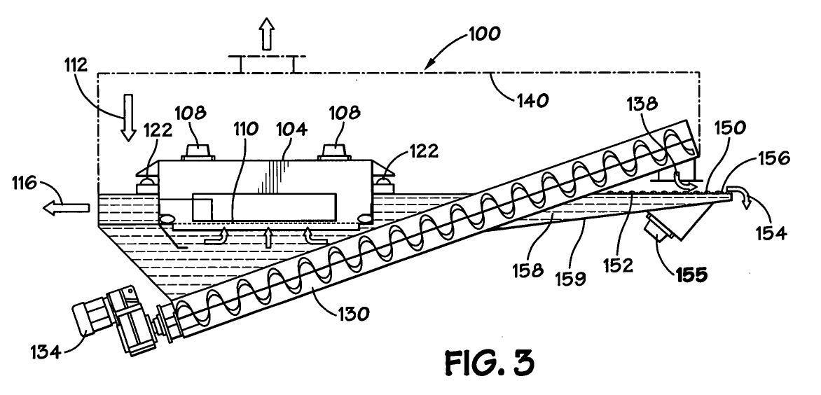

FIG. 3 illustrates one embodiment of the system 100 (and like numerals indicate like parts) which includes a screen apparatus 150 which receives the discharged material 138. It is within the scope of the present invention for the screen apparatus 150 to be inclined downwardly and for material to move off of it under the influence of gravity; or, as shown, in FIG. 3 the screen apparatus 150 includes vibratory apparatus 155 (like, e.g. the vibratory apparatus 108) which vibrates a screen or screens 152 (e.g. like the screen apparatus 110). Separated solids 154 flow off an exit end 156 of the screen(s) 152 and reclaimed fluid 158 flows to a receptacle or container 159.

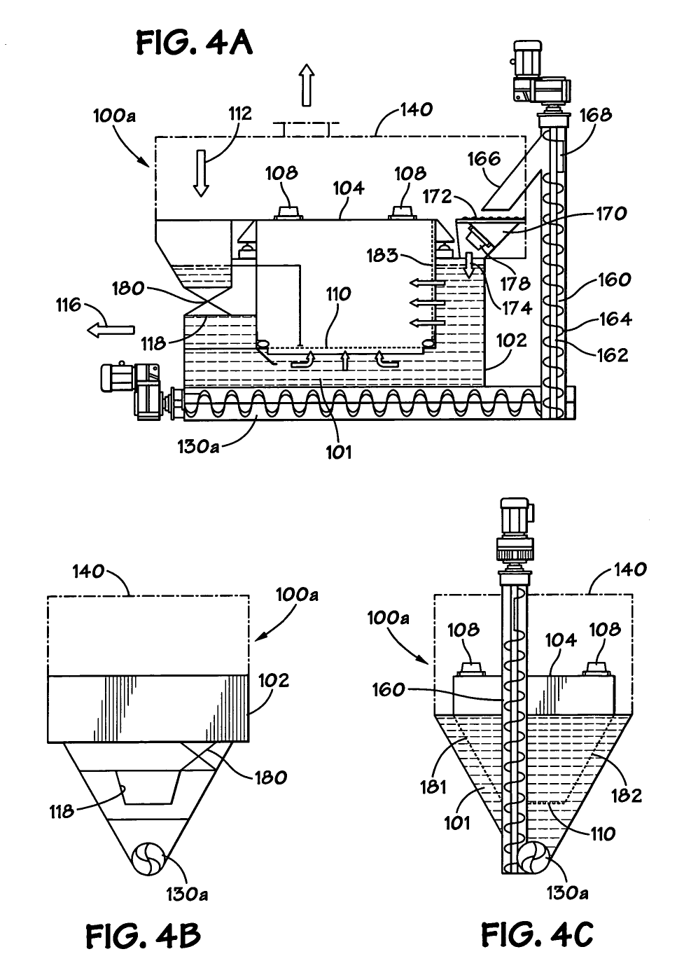

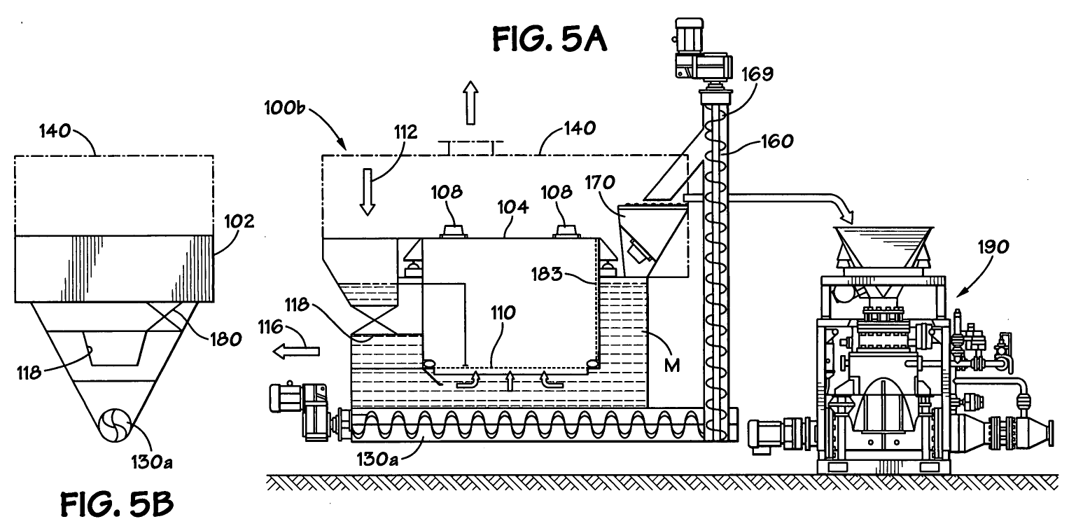

FIGS. 4A-4C illustrate an embodiment of a system 100 according to the present invention (like numerals indicate like parts) which includes at least one additional conveyor system 160 (like the conveyor system 130) which is oriented in a generally vertical orientation. A conveyor system 130a, like the system 130, may be oriented as shown in FIG. 2A or, as shown in FIG. 4A, may be oriented generally horizontally. The conveyor system 130a moves material with separated solids to the conveyor system 160 which, in turn, moves the material up to an exit duct 166. An optional paddle 168, secured to an auger apparatus 162 of the system 160 so that it is adjacent the duct 166, facilitates the movement of material into the exit duct 166. In one aspect the paddle 168 is a straight blade section on the auger apparatus 162 (as opposed to screw flights on the rest of the auger apparatus 162). Optionally, in one aspect a reversed flight 169 is used at the top of the auger apparatus (see, e.g. FIG. 5A) which moves material downwardly to the duct 166. Such a flight 169 can be used with the paddle 168.

Material with separated solids may, according to the present invention, flow to storage or to further processing or, as shown in FIG. 4A, may be introduced to a vibratory separator apparatus 170 with screening apparatus 172 (like the screening apparatus 110) vibrated by vibratory apparatus 178 (like the vibratory apparatus 108). It is within the scope of the present invention for the material with solids separated by the vibratory separator apparatus to flow to disposal, to storage, or to further processing. Reclaimed fluid from the vibratory separator apparatus 170 can be directed to storage or to a container; or, as shown in FIG. 4A by an arrow 174, it can flow back into the housing 102.

Optionally, a valve 180 selectively controls the flow of fluid into the housing 102. Optionally, in addition to (or instead of) the screen apparatus 110, one or more walls of the box 104 may have a screen mounted therein or thereon, or a screen or screens can be secured to the box 104. For example, as shown in FIG. 4C two inclined screens 181, 182 (like the screen apparatus 110) are secured to the box 104 and material 101 is flowable through the screens 181, 182 and through the screen apparatus 110. Additionally, and/or optionally, a further screen 183, oriented generally vertically, may be secured to a vertical face 184 of the box 104.

In certain aspects, the use of an additional conveyor, such as the conveyor system 160, makes it possible for the material depth within the housing 102 to be increased as compared to a system with a lower conveyor system or systems. This can permit a screen apparatus to be set relatively deeper in a box which can result in side screens being relatively taller so that more screening area is provided in a specified footprint area. In certain aspects according to the present invention, to empty a system as in FIG. 4A, a height adjustment is made for both the box 104 and the duct 118.

FIG. 5A illustrates a system 100b like the system 100a of FIG. 4A (like numerals indicate like parts) which includes a solids conveying system 190. Solids separated by the vibratory separator apparatus 170 are introduced to the solids conveying system 190. In one particular aspect the solids introduced to the system 190 are drilled cuttings separated from a material that includes drilling fluid and drilled solids (“drilled cuttings”) and the system 190 is a drilled cuttings conveyance system. It is within the scope of the present invention to employ any suitable known cuttings conveyance system for the system 190.

As shown in FIG. 6 a system 196 according to the present invention may have a plurality of vibratory separators 191, 192, 193 (as any according to the present invention; in one aspect, each vibratory separator is a shale shaker processing drilling material). Material to be processed flows in a feed conduit or “gutter” 195 and each separator or shaker 191-193 has a flow valve 180a, 180b, 180c, respectively which selectively controls flow to each separator or shaker 191-193. Thus one, two or three separators or shakers 191-193 can be operational as desired. It is within the scope of the present invention to provide one, two, three, four, five, six or more separators or shakers in a system 196 according to the present invention.

In certain of the claims that follow, “non-motorized vibrator apparatus” includes vibrators that are electromagnetic vibrators, or piezoelectric vibrators. Exemplary electromagnetic vibrator apparatuses are disclosed in U.S. Pat. Nos. 4,836,385; 6,543,620; 6,938,778; and 6,953,122; and exemplary piezoelectric vibrator apparatuses are disclosed in U.S. Pat. Nos. 6,543,620; 6,938,778; and 6,953,122—all of said patents incorporated fully herein.

The present invention, therefore, provides in certain, but not necessarily all embodiments, an upflow vibratory separator including: a box, a primary screen assembly in the box, a container, the box and the primary screen assembly in the container, vibratory apparatus for vibrating the primary screen assembly, at least part of the container disposed beneath the primary screen assembly, and the vibratory apparatus comprising electromagnetic vibratory apparatus or piezoelectric vibrator apparatus. Such an upflow vibratory separator may include one or some, in any possible combination, of the following: a primary conveyor beneath the primary screen assembly for removing solids that do not pass through the primary screen assembly; a material input for introducing the material into the container, a deflector adjacent the material input for directing material flowing through the material input away from the primary screen assembly; wherein the solids include liquid, the upflow vibratory separator further including separation apparatus for receiving solids conveyed by the primary conveyor, the separating apparatus for separating liquid from the solids; wherein the separation apparatus includes a secondary screen assembly for separating the solids from the liquid, the liquid flowing down through the secondary screen assembly; vibration apparatus for vibrating the secondary screen assembly; wherein the material is drilling material including drilling fluid and drilled solids; a secondary container for receiving and containing fumes from the material; evacuation apparatus for removing the fumes from the secondary container; filtration apparatus for filtering the fumes from the secondary container; the primary screen assembly mounted generally horizontally, and at least one tertiary screen assembly mounted non-horizontally for treating the material; wherein the at least one tertiary screen assembly is two spaced-apart tertiary screen assemblies, each extending upwardly from the primary screen assembly; a valve for controlling flow of material into the container; a secondary conveyor for receiving the solids conveyed by the primary conveyor and for conveying the solids away from the primary conveyor, the solids including liquid; wherein the secondary conveyor has an exit through which solids including liquid exit for further processing; the secondary conveyor including auger apparatus for moving the solids including liquid to the exit; a paddle on the auger apparatus for moving solids including liquid to the exit; secondary vibratory separator apparatus for receiving solids including liquid from the exit of the secondary conveyor and for treating the solids including liquid, the secondary vibratory separator apparatus for producing separated solids and for producing liquid for introduction back into the container; solids conveying apparatus for receiving the solids from the secondary vibratory separator apparatus and for conveying the solids away from the upflow vibratory separator; and/or the primary conveyor including a plurality of spaced-apart auger apparatuses for moving the solids away from the upflow vibratory separator.

The present invention, therefore, provides in certain, but not necessarily all embodiments, in a method of removing debris from drilling fluid, comprising passing the fluid through a screen which lies in a plane which is not vertical so that one face of the screen is directed generally downwardly and the opposite face is directed generally upwardly, characterized by passing the fluid through the screen from the side of the screen having the generally downwardly directed face through to the side having the generally upwardly directed face, the improvement of vibrating the screen with non-motorized vibrator apparatus; and in an apparatus for doing this the improvement of vibration apparatus for vibrating the screen, the vibration apparatus comprising non-motorized vibrator apparatus.

The present invention, therefore, provides in certain, but not necessarily all embodiments, a method for treating material with an upflow vibratory separator, the upflow vibratory separator including, optionally, a primary conveyor beneath a primary screen assembly in a box for removing solids that do not pass through the primary screen assembly, the upflow vibratory separator being an upflow vibratory separator in which material to be treated flows up to the primary screen assembly and fluid in the material flows up and through the primary screen assembly and solids in the material contact and do not flow through the primary screen assembly, the material flowing from a container to the primary screen assembly, vibratory apparatus for vibrating the primary screen assembly, the vibratory apparatus including non-motorized vibrator apparatus, at least part of the container disposed beneath the primary screen assembly, the method including flowing the material to the primary screen assembly and with the primary screen assembly filtering out solids from the material, the solids flowing downwardly in the container, and vibrating the primary screen assembly with the vibratory apparatus.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventor may rely on the Doctrine of Equivalents to determine and assess the scope of their invention and of the claims that follow as they may pertain to apparatus not materially departing from, but outside of, the literal scope of the invention as set forth in the following claims. Any patent or patent application referred to herein is incorporated fully herein for all purposes.

What is claimed is:

1. An upflow vibratory separator comprising
a box,
a primary screen assembly in the box,
a container, the box and the primary screen assembly in the container,
vibratory apparatus for vibrating the primary screen assembly,
at least part of the container disposed beneath the primary screen assembly, and
the vibratory apparatus comprising electromagnetic vibratory apparatus.

2. The upflow vibratory separator of claim 1 further comprising
a primary conveyor beneath the primary screen assembly for removing solids that do not pass through the primary screen assembly.

3. The upflow vibratory separator of claim 1 further comprising
a material input for introducing the material into the container,
a deflector adjacent the material input for directing material flowing through the material input away from the primary screen assembly.

4. The upflow vibratory separator of claim 1 wherein the solids include liquid, the upflow vibratory separator further comprising
separation apparatus for receiving solids conveyed by the primary conveyor, the separating apparatus for separating liquid from the solids.

5. The upflow vibratory separator of claim 4 wherein the separation apparatus includes a secondary screen assembly for separating the solids from the liquid, the liquid flowing down through the secondary screen assembly.

6. The upflow vibratory separator of claim 5 further comprising
vibration apparatus for vibrating the secondary screen assembly.

7. The upflow vibratory separator of claim 1 wherein the material is drilling material including drilling fluid and drilled solids.

8. The upflow vibratory separator of claim 1 further comprising
a secondary container for receiving and containing fumes from the material.

9. The upflow vibratory separator of claim 8 further comprising
evacuation apparatus for removing the fumes from the secondary container.

10. The upflow vibratory separator of claim 9 further comprising
filtration apparatus for filtering the fumes from the secondary container.

11. The upflow vibratory separator of claim 1 further comprising
the primary screen assembly mounted generally horizontally, and
at least one tertiary screen assembly mounted non-horizontally for treating the material.

12. The upflow vibratory separator of claim 11 wherein the at least one tertiary screen assembly is two spaced-apart tertiary screen assemblies, each extending upwardly from the primary screen assembly.

13. The upflow vibratory separator of claim 1 further comprising
a valve for controlling flow of material into the container.

14. The upflow vibratory separator of claim 1 further comprising
a secondary conveyor for receiving the solids conveyed by the primary conveyor and for conveying the solids away from the primary conveyor, the solids including liquid.

15. The upflow vibratory separator of claim 14 wherein the secondary conveyor has an exit through which solids including liquid exit for further processing.

16. The upflow vibratory separator of claim 15 further comprising
the secondary conveyor including auger apparatus for moving the solids including liquid to the exit.

17. The upflow vibratory separator of claim 16 further comprising
a paddle on the auger apparatus for moving solids including liquid to the exit.

18. The upflow vibratory separator of claim 15 further comprising
secondary vibratory separator apparatus for receiving solids including liquid from the exit of the secondary conveyor and for treating the solids including liquid, the secondary vibratory separator apparatus for producing separated solids and for producing liquid for introduction back into the container.

19. The upflow vibratory separator of claim 18 further comprising
solids conveying apparatus for receiving the solids from the secondary vibratory separator apparatus and for conveying the solids away from the upflow vibratory separator.

20. The upflow vibratory separator of claim 16 further comprising
the primary conveyor including a plurality of spaced-apart auger apparatuses for moving the solids away from the upflow vibratory separator.

21. An upflow vibratory separator comprising
a box,
a primary screen assembly in the box,
a container, the box and the primary screen assembly in the container,
vibratory apparatus for vibrating the primary screen assembly,
at least part of the container disposed beneath the primary screen assembly, and
the vibratory apparatus comprising piezoelectric vibratory apparatus.

22. In a method of removing debris from drilling fluid, comprising passing the fluid through a screen which lies in a plane which is not vertical so that one face of the screen is directed generally downwardly and the opposite face is directed generally upwardly, characterized by passing the fluid through the screen from the side of the screen having the generally downwardly directed face through to the side having the generally upwardly directed face, the improvement comprising
vibrating the screen with non-motorized vibrator apparatus.

23. In an apparatus for removing debris from drilling fluid, comprising a screen which lies in a plane which is not vertical so that one face of the screen is directed generally downwardly and the opposite face is directed generally upwardly, and means for introducing the fluid to the screen such that the fluid passes through the screen from the side of the screen having the generally downwardly directed face through to the side having the generally upwardly directed face, the improvement comprising
vibration apparatus for vibrating the screen, the vibration apparatus comprising non-motorized vibrator apparatus.

24. A method for treating material with an upflow vibratory separator, the upflow vibratory separator comprising, optionally, a primary conveyor beneath a primary screen assembly in a box for removing solids that do not pass through the primary screen assembly, the upflow vibratory separator comprising an upflow vibratory separator in which material to be treated flows up to the primary screen assembly and fluid in the material flows up and through the primary screen assembly and solids in the material contact and do not flow through the primary screen assembly, the material flowing from a container to the primary screen assembly, vibratory apparatus for vibrating the primary screen assembly, the vibratory apparatus comprising non-motorized vibrator apparatus, at least part of the container disposed beneath the primary screen assembly, the method comprising
flowing the material to the primary screen assembly and with the primary screen assembly filtering out solids from the material, the solids flowing downwardly in the container, and
vibrating the primary screen assembly with the vibratory apparatus.
